(19) United States
(12) Patent Application Publication
(10) Pub. No.: US 2014/0331068 A1
(43) Pub. Date: Nov. 6, 2014

(54) SYSTEM AND METHOD FOR MANAGING POWER SUPPLY UNITS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: WEI-HUA CAO, Shenzhen (CN)

(73) Assignees: HON HAI PRECISION INDUSTRY CO., LTD., New Taipe (TW); HONG FU JIN PRECISION INDUSTRY (ShenZhen) CO., LTD., Shenzhen (CN)

(21) Appl. No.: 14/093,524

(22) Filed: Dec. 2, 2013

(30) Foreign Application Priority Data
May 2, 2013 (CN) 2013101581375

(51) Int. Cl. G06F 1/32

(52) U.S. Cl. CPC G06F 1/329
USPC 713/323

(57) ABSTRACT

A system for controlling a plurality of power supply units to provide power to a server, includes a priority level definition module and a control module. The priority level definition module defines priority level for each one of the plurality of power supply units. The control module prior power on part of plurality of power supply units, which have high level priority, to provide power to the server.

### BACKGROUND

1. Technical Field

The disclosure generally relates to power management, and more particularly relates to a system and method for managing power supply units.

2. Description of Related Art

With the advent of power-hungry information handling systems, power management has become more important. In the past, power conservation has often been a secondary consideration to speed and processor availability. However, due to the increased processing demands required by modern information handling systems, more information handling systems utilize multi-processor systems and/or multiple-blade systems that require more power to operate than single-processor computer systems. In addition, as processor designs continue to scale up in speed and density, corresponding power consumption can increase dramatically. In certain applications (e.g., Internet servers), multiple redundant power supplies are often employed to reduce or eliminate downtime in the event of a power supply failure, requiring more efficient power management.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a system for managing power supply units.

FIG. 2 is a flow chart showing one embodiment of a method for managing power supply units.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

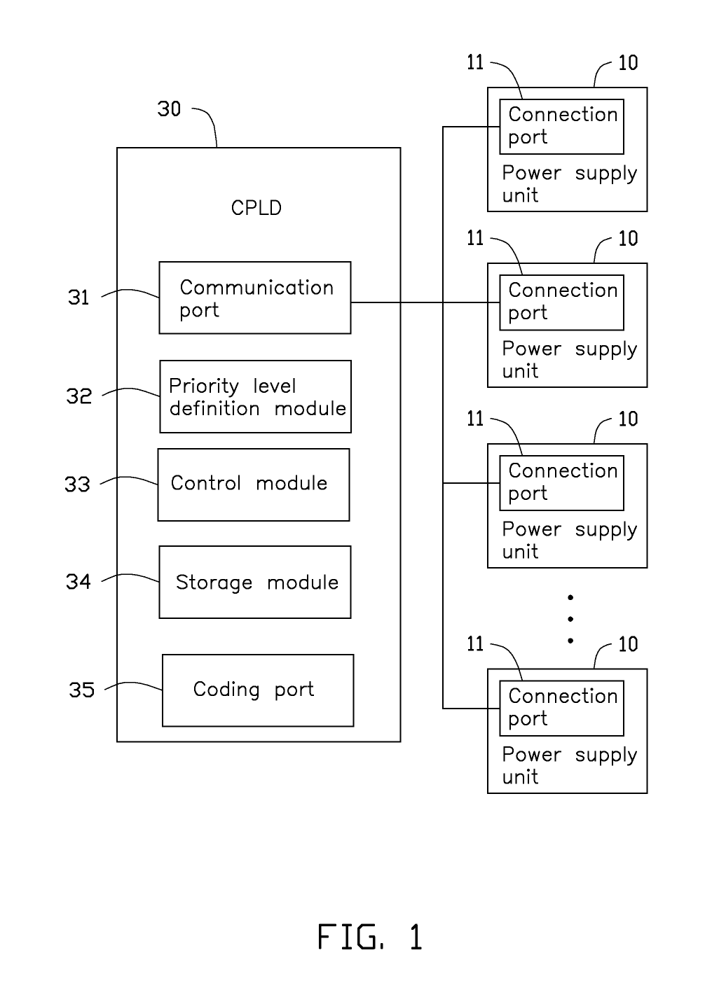

FIG. 1 shows one embodiment of a system for managing a plurality of power supply units 10. The system comprises a complex programmable logic device (CPLD) 30. Each of the plurality of power supply units 10 includes a connection port 11. In one embodiment, the connection port 11 is an Inter-Integrated Circuit (I2C) port.

The CPLD 30 includes a communication port 31, a priority level definition module 32, a control module 33, a storage module 34, and a coding port 35. In one embodiment, the communication port 31 is an I2C port. The communication port 31 is connected to the connection port 11 of the power supply unit 10 to receive information about the power supply unit 10. For example, the power supply unit 10 can transmit information about a current power output of the power supply unit 10 to the CPLD 30 via the communication port 31.

The priority level definition module 32 can define different priority levels for each one of the plurality of power supply units 10. Because the plurality of power supply units 10 are usually mounted in different positions in a server, some power supply units 10 are located adjacent to power consumption components of the server, and some power supply units 10 are located away from the power consumption components of the server. The power supply unit 10, which is located adjacent to the power consumption components, often has a higher efficiency than other power supply units 10, which are located far away from the power consumption components. Therefore, the power supply unit 10 located adjacent to the power consumption components, is defined as a high level priority by the priority level definition module 32. In another aspect, a power supply unit 10, which has a larger rated power output, often has a higher efficiency than another power supply unit 10, which has a smaller rated power output. Therefore, the power supply unit 10 having a larger rated power output is defined as a high level priority by the priority level definition module 32. The power supply unit 10, which has a high level priority, is provided power first.

The control module 33 can power on and power off each of the plurality of power supply units 10. The control module 33 sets an output power margin percent. For example, a total current power output of the plurality of power supply units 10 are 1000 W, and the control module 33 sets the output power margin percent to 20%, so the control module 33 powers on part of the plurality of power supply units 10 to make sure a total rated power output is equal to or larger than 1200 W. If each one of the plurality of power supply units 10 has a 500 W rated power output, the control module 33 powers on three power supply units 10 which are defined as high level priority. If each one of the plurality of power supply units 10 has a 300 W rated power output, the control module 33 powers on four power supply units 10 which are defined as high level priority.

The storage module 34 can store information which needs to be processed by the CPLD 30. The information includes a priority level of each power supply unit 10 defined by the priority level definition module 32, a rated power output of each power supply unit 10, and the output power margin percent.

The coding port 35 can connect to a peripheral device to edit the information stored in the storage module 34.

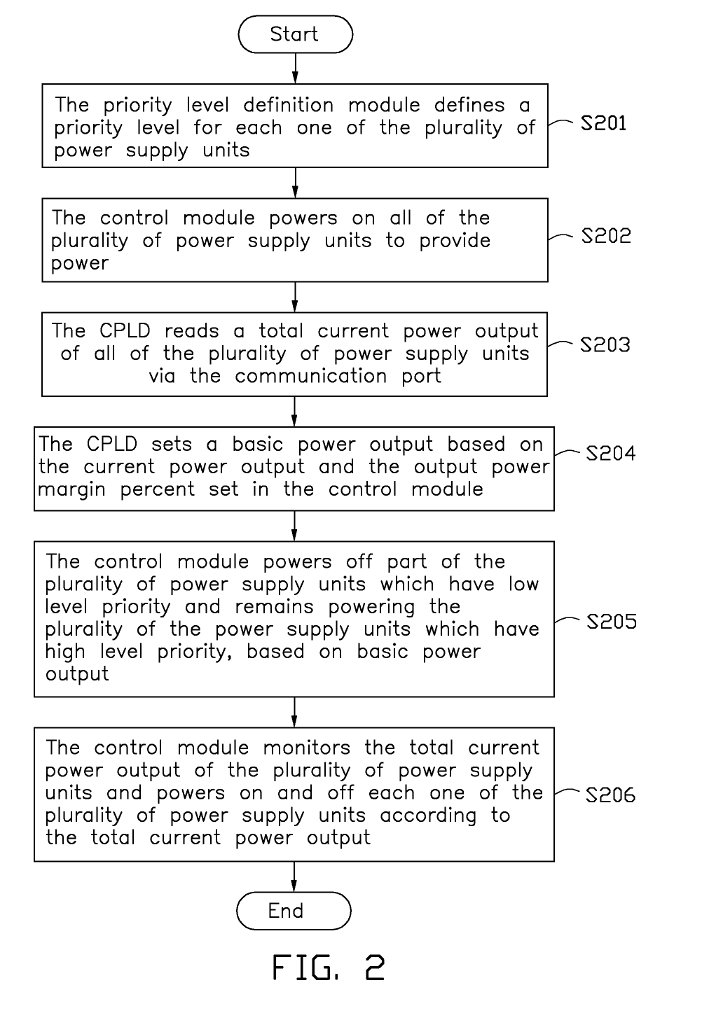

FIG. 2 is a flowchart showing one embodiment of a method for managing the plurality of power supply units 10. The method comprises the following steps.

In step S201, the priority level definition module 32 defines a priority level for each one of the plurality of power supply units 10.

In step S202, the control module 33 powers on all of the plurality of power supply units 10 to provide power.

In step S203, the CPLD 30 reads a total current power output of all of the plurality of power supply units 10 via the communication port 31.

In step S204, the CPLD 30 sets a basic power output based on the current power output and the output power margin percent set in the control module 33.

In step S205, the control module 33 powers off part of the plurality of power supply units 10 which have low level priority, and remains powering the plurality of the power supply units 10 which have high level priority based on basic power output. For example, if the basic power output is 1200 W and each one of the plurality of power supply units 10 has a 300 W rated power output, the control module 33 remains powering on four power supply units 10 which have high priority level, and powers off the other power supply units 10.

In step S206, the control module 33 monitors the total current power output of the plurality of power supply units 10 and powers on and off each one of the plurality of power supply units 10 according to the total current power output.

Although numerous characteristics and advantages have been set forth in the foregoing description of embodiments, together with details of the structures and functions of the embodiments, the disclosure is illustrative only, and changes can be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A system for controlling a plurality of power supply units to provide power to a server, the system comprising:
a priority level definition module configured to define a priority level for each one of the plurality of power supply units; and
a control module configured to power the plurality of power supply units which have a high level priority.

2. The system of claim 1, wherein the control module sets a power margin percent, and a total current power output of the plurality of power supply units multiplied with the power margin percent is less than a total rated power output of the powered on power supply units of the plurality of power supply units minus the total current power output of the plurality of power supply units.

3. The system of claim 2, further comprising a complex programmable logic device (CPD), wherein the CPLD comprises the priority level definition module, the control module, and a storage module which stores the priority level of the each one of the plurality of power supply units defined by the priority level definition module, a rated power output of each power supply unit, and the output power margin percent therein.

4. The system of claim 3, wherein the CPLD further comprises a coding port configured to be connected to a peripheral device to edit the information stored in the storage module.

5. The system of claim 2, wherein each power supply unit comprises a connection port, and the CPLD further comprises a communication port connected to the connection port of each power supply unit.

6. The system of claim 1, wherein the priority level definition module defines the priority level for each power supply unit according to a rated power output of each power supply unit.

7. The system of claim 6, wherein the priority level definition module further defines the priority level for each power supply unit according to a distance between the power supply unit and power consumption components of the server.

8. A method for controlling a plurality of power supply units to provide power to a server, the method comprising:
a priority level definition module defining a priority level for each one of the plurality of power supply units;
a control module powering on all of the plurality of power supply units; and
the control module powering off part of the plurality of power supply units which have low level priority, and maintaining power on the other of the plurality of the power supply units which have high level priority based on a total current power output of the plurality of power supply units.

9. The method of claim 8, further comprising providing a complex programmable logic device (CPD), wherein the CPLD comprises the priority level definition module and the control module, the control module set a power margin percent, the CPLD sets a basic power output based on the total current power output and the output power margin percent, and a total rated power output of the powered on power supply units of the plurality of power supply units is larger than the basic power output.

10. The method of claim 9, wherein the CPLD further comprises a storage module, and the storage module stores the priority level of the each one of the plurality of power supply units defined by the priority level definition module, a rated power output of each power supply unit, and the output power margin percent therein.

11. The method of claim 10, wherein the CPLD further comprises a coding port configured to be connected to a peripheral device to edit the information stored in the storage module.

12. The method of claim 8, wherein the priority level definition module defines the priority level for each power supply unit according to a rated power output of each power supply unit.

13. The method of claim 12, wherein the priority level definition module further defines the priority level for each power supply unit according to a distance between the power supply unit and power consumption components of the server.
